(19) United States
(12) Patent Application Publication
(10) Pub. No.: US 2024/0393496 A1
(43) Pub. Date: Nov. 28, 2024

(54) METHOD FOR GEOLOGICAL MODEL CONSTRUCTION AND STABILITY SIMULATION OF LARGE LANDSLIDES BASED ON GEOPHYSICAL DATA

(71) Applicant: Institute of Geomechanics, Chinese Academy of Geological Sciences, Beijing (CN)

(72) Inventors: Changbao GUO, Beijing (CN); Zhendong QIU, Beijing (CN); Yiqiu YAN, Beijing (CN); Ruian WU, Beijing (CN); Yang WANG, Beijing (CN); Gui LIU, Beijing (CN); Ning ZHONG, Beijing (CN); Hao YUAN, Beijing (CN)

(21) Appl. No.: 18/741,185

(22) Filed: Jun. 12, 2024

(51) Int. Cl. G01V 20/00; G01V 1/28; G01V 1/30

(52) U.S. Cl. CPC G01V 20/00; G01V 1/284; G01V 1/307; G01V 2210/665

(57) ABSTRACT

A method for simulating landslide stability based on geophysical exploration data is provided. Electrical resistivity ρ of a to-be-detected rock-soil mass in a landslide area is measured. Geophysical exploration data of a landslide profile is acquired and processed, and an electrical resistivity profile is obtained by inversion. The electrical resistivity profile is subjected to interpret partition to obtain a corresponding landslide geological model. A relationship model between shear strength parameters and physical property parameters of a typical rock-soil mass is established. Shear strength parameters of the to-be-detected rock-soil mass are calculated according to the relationship model. A preset condition is loaded into the landslide geological model. A landslide stability numerical simulation result is outputted to evaluate the landslide stability.

### TECHNICAL FIELD

This application relates to landslide prevention and control, and more particularly to a method for simulating landslide stability based on geophysical exploration data.

### BACKGROUND

Landslide prevention and control refers to the prevention and control measures taken when the engineering construction is unavoidably carried out in areas with landslides or unstable slopes. Landslide stability analysis plays a fundamental role in the landslide prevention and control. For the potentially unstable slopes or landslides in the complex geology condition, affected by long-term tectonic evolution and fault activity, the rock mass generally presents a fragmented-layered structure, and the rock formation is subjected to strong compression and wrinkling, resulting in obvious foliation. Moreover, multiple joints and fissures are developed in the rock mass. Under the exposure to internal and external factors (such as earthquake, rainfall, river erosion, human engineering activities, etc.), the slope is prone to instability sliding. Therefore, the landslide stability analysis in the complex geology condition can not only provide a scientific theoretical basis for the engineering construction, but also plays an important guiding role in the early warning and prediction of landslides.

At present, the landslide stability is commonly evaluated or investigated by combined qualitative and quantitative analysis, and the numerical simulation result is used as a reference for evaluating the landslide stability. However, there are several problems in the traditional landslide modeling process of numerical simulation.

(1) The complex geological environmental factors, such as topography, geological structure and stratum lithology, will significantly affect the artificial geological modeling.

(2) The geological survey precision is poor, and the acquisition of rock and soil parameters has low efficiency and poor precision.

(3) Due to the differences in understanding the complex spatial structure of the landslide, the geological modeling is relatively rough, resulting in insufficient accuracy of the established landslide geological model.

These problems will make the numerical simulation result different from the actual situation, failing to accurately reflect the actual stability state of the landslide.

Therefore, it is necessary to develop a method for accurately and reliably reflecting the landslide stability to overcome the problems in the prior art.

### SUMMARY

An object of the disclosure is to provide a method for simulating landslide stability in a complex geology condition based on geophysical exploration data, so as to overcome the problems in the prior art that it fails to rapidly establish a refined geological model conforming to the actual landslide situation, and rapidly acquire shear strength parameters of the rock-soil mass for rapid evaluation of the landslide stability.

In order to achieve the above object, the following technical solutions are adopted.

This application provides a method for simulating landslide stability based on geophysical exploration data, comprising:
(S10) measuring an electrical resistivity of a to-be-detected rock-soil mass in a landslide area, acquiring and processing geophysical exploration data of a profile of the landslide area, and generating an electrical resistivity profile by inversion based on the geophysical exploration data;
(S20) subjecting the electrical resistivity profile to interpret partition to establish a landslide geological model;
(S30) establishing a relationship model between shear strength parameters of a typical rock-soil mass and physical parameters of the typical rock-soil mass, and calculating shear strength parameters of the to-be-detected rock-soil mass according to the relationship model; and
(S40) loading a preset condition into the landslide geological model, and outputting a landslide stability numerical simulation result to evaluate stability of the landslide area.

In some embodiments, the step (S20) is performed through steps of:
(S201) interpreting and analyzing a result of the inversion according to the electrical resistivity profile in combination with on-site investigation and basic geological data;
(S202) subjecting the to-be-detected rock-soil mass to physical property measurement to obtain an electrical resistivity value corresponding to the to-be-detected rock-soil mass, analyzing electrical resistivity P values of a plurality of lithological zones on site, zoning the to-be-detected rock-soil mass according to lithological distribution characteristics, and delineating predefined geological bodies within the landslide area; and
(S203) establishing the landslide geological model comprising the electrical resistivity ρ.

In some embodiments, the step (S30) is performed through steps of:
establishing the relationship model between shear strength parameters C and φ and an electrical resistivity ρ of the typical rock-soil mass; and calculating the shear strength parameters of the to-be-detected rock-soil mass according to the relationship model in combination with the electrical resistivity profile; wherein C represents cohesion, and φ represents internal friction angle.

In some embodiments, the shear strength parameters C and φ of the typical rock-soil mass are calculated by substituting the electrical resistivity ρ of the plurality of lithologic zones into preset equations (1)-(2) or preset equations (3)-(4).

The preset equations (1)-(4) are expressed as follows:
for a gravel soil, the preset equations (1)-(2) are adopted, expressed as:

$$c = ( - 1.13 \times 1 {0}^{14} ) \times {e}^{- ρ / ( 1.12 \times 1 {0}^{13} )} + 1.13 \times 1 {0}^{14} ; and \qquad ( 1 )$$

$$φ = \frac{- 22.19}{1 + {( ρ / 2.8 )}^{44.99}} + 6 0.4 ; \qquad ( 2 )$$

for a rock mass, the preset equations (3)-(4) are adopted, expressed as:

$$c = \frac{- 11479.09}{1 + {( ρ / 2.78 )}^{20.33}} + 19 518.89 ; and \qquad ( 3 )$$

$$φ = \frac{- 4.78}{1 + {( ρ / 2.47 )}^{52.84}} + 32 \text{.85} . \qquad ( 4 )$$

In some embodiments, in step (S40), the preset condition comprises a rainfall loading boundary condition, an earthquake loading boundary condition or a combination thereof, a stratum lithologic distribution depth condition and cohesion c and internal friction angle φ of each of the plurality of lithologic zones.

Compared with the prior art, this disclosure has the following advantages.

(1) The method of the present disclosure adopts geophysical exploration inversion imaging technology to obtain the electrical resistivity profile, which overcomes the problems of unclear understanding and inaccurate identification of a landslide spatial structure under complex geological conditions, thus rapidly establishing a refined landslide geological model.

(2) The relationship model between the physical property parameter (the electrical resistivity ρ) and the shear strength parameters (cohesion C and internal friction angle φ) of the rock-soil mass is established. Combined with the result of the electrical resistivity profile, the shear strength parameters of the landslide rock-soil mass can be rapidly obtained. This overcomes the problems of low speed and accuracy in acquiring geotechnical parameters during an exploration stage.

(3) Based on rapid modeling and rapid acquisition of the shear strength parameters of the rock-soil mass. A detailed numerical simulation of the stability of the landslide geological model is performed using a numerical simulation software to analyze the landslide stability.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a flow chart of a method for simulating landslide stability based on geophysical exploration data in accordance with an embodiment of the present disclosure;

FIG. 2 is a schematic diagram of the method in accordance with an embodiment of the present disclosure;

FIG. 3 shows an electrical resistivity profile of a landslide obtained by inversion of the geophysical exploration data in accordance with an embodiment of the present disclosure;

FIG. 4 is a schematic diagram of a refined geological model in accordance with an embodiment of the present disclosure;

FIG. 5 shows an X-direction displacement cloud map of a landslide numerical simulation calculation process in accordance with an embodiment of the present disclosure;

FIG. 6 shows an X-direction displacement cloud map of a landslide numerical simulation calculation result in accordance with an embodiment of the present disclosure;

FIG. 7 shows a maximum shear strain increment cloud map of the landslide numerical simulation calculation process in accordance with an embodiment of the present disclosure; and

FIG. 8 shows a maximum shear strain increment cloud map of the landslide numerical simulation calculation result in accordance with an embodiment of the present disclosure.

### DETAILED DESCRIPTION OF EMBODIMENTS

In order to make the purpose, technical solutions and advantages of the present disclosure clearer, the present disclosure will be further described in detail below in conjunction with the embodiments.

As used herein, orientation or positional relationships indicated by terms such as “upper”, “lower”, “inner”, “outer”, “front end”, “rear end”, “two ends”, “one end” and “the other end” are based on orientation or position relationships shown in the drawings, which are merely intended to facilitate the description of the embodiments and simplify the description, and are not intended to indicate or imply that a device or element referred to must have a specific orientation, be established and operated in a specific orientation. Therefore, these orientation or positional terms cannot be construed as limiting the present disclosure. In addition, terms, such as “first” and “second”, are merely descriptive, and are not intended to indicate or imply the relative importance of indicated technical features.

As used herein, it should be understood that unless otherwise clearly specified and defined, terms, such as “mount”, “provide” and “connect”, should be understood in a broad sense. For example, “connect” can indicate a fixed connection, a detachable connection, or an integrated connection; it can be a mechanical connection or an electrical connection; it can be a direct connection or an indirect connection through an intermediate medium, or it can be an internal connection between two elements. For those of ordinary skill in the art, the specific meanings of the above terms in the present disclosure can be understood according to specific circumstances.

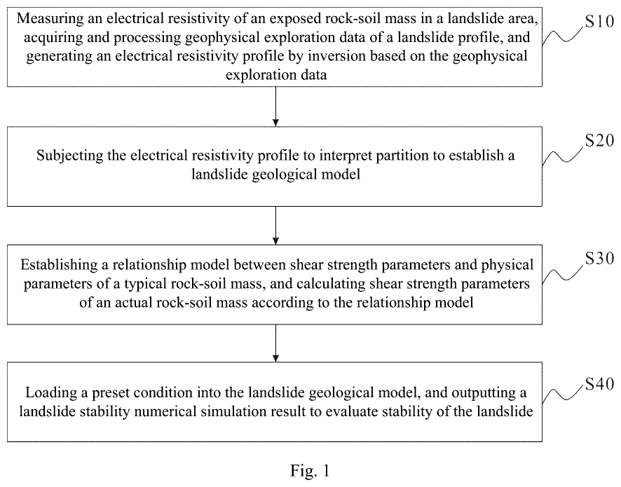

As shown in FIG. 1, a method for simulating landslide stability based on geophysical exploration data is provided, which includes the following steps.

(S10) An electrical resistivity of a to-be-detected rock-soil mass in a landslide area is measured. Geophysical exploration data of a profile of the landslide area is acquired and processed. Then, an electrical resistivity profile is generated by inversion based on the geophysical exploration data.

(S20) The electrical resistivity profile is subjected to interpret partition to establish a corresponding landslide geological model.

(S30) A relationship model between shear strength parameters and physical property parameters of a typical rock-soil mass is established. Shear strength parameters of the to-be-detected rock-soil mass are calculated according to the relationship model.

(S40) A preset condition is loaded into the landslide geological model. A landslide stability numerical simulation result is output to evaluate stability of the landslide area.

For potentially unstable slopes or landslides in the complex geology condition, affected by long-term tectonic evolution and fault activity, a slope rock mass presents a fragmented-layered structure, and the rock formation is subjected to strong compression and wrinkling, resulting in obvious foliation. Multiple joints and fissures are developed in the rock mass. Under the exposure to internal and external factors (such as earthquake, rainfall, river erosion, human engineering activities, etc.), there are certain impacts on the stability of the landslide. Therefore, geophysical exploration can not only delineate a precise range of the rock-soil mass, but also infer shear strength parameters (cohesion C and internal friction angle Q) of the rock-soil mass according to the geophysical exploration result (the electrical resistivity p). This facilitates the improvement of the accuracy of landslide modeling and the rapid acquisition of the shear strength values of the corresponding rock-soil mass, which provides a basis for the further numerical simulation calculation of landslide stability.

The method of the present disclosure adopts geophysical exploration to obtain the electrical resistivity profile, which overcomes the problems of unclear understanding and inaccurate identification of a landslide spatial structure under complex geological conditions, thus rapidly establishing a refined landslide geological model. The refined landslide geological model is further subjected to stability numerical simulation calculation to achieve accurate evaluation and analysis of landslide stability.

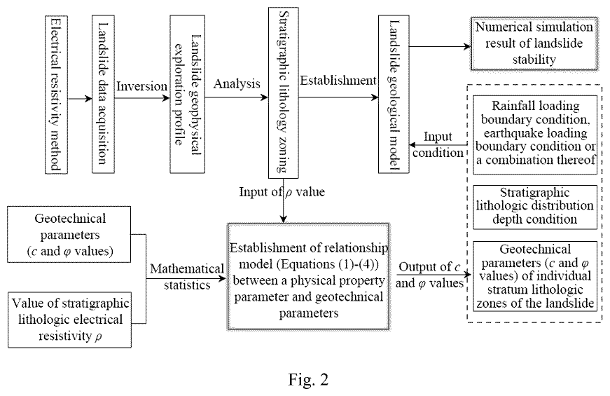

The steps of the above method will be described in detail below with reference to FIG. 2.

Firstly, in step (S10), data on a spatial structure of the landslide is acquired by means of a geophysical exploration technique. A survey line needs to be reasonably deployed along a sliding direction of the landslide. A high-density resistivity method is adopted, and electrodes are deployed for field data collection. The obtained data is processed and inverted to obtain an electrical resistivity profile along the landslide.

Secondly, in step (S20), based on the results of geophysical inversion (i.e., the geophysical resistivity profile), combined with on-site ground surveys, including potential fault zones, exposed rock lithology, possible surface and subsurface water accumulation areas, as well as basic geological data such as stratigraphic lithology and geological structures, the geophysical result is interpreted. Combined with the measurement of an original physical parameter (the electrical resistivity P) of the rock-soil mass, the to-be-detected rock-soil mass is zoned according to lithology distribution characteristics. Moreover, special geological bodies in the landslide body (such as a fracture zone, a karst development area and an isolated rock) are delineated, thereby establishing the landslide geological model containing the landslide physical property parameter (the electrical resistivity ρ).

The to-be-detected rock-soil mass is subjected to physical property measurement on site. The geophysical exploration data is acquired and processed, and geophysical exploration profile image (the electrical resistivity profile) is generated by inversion based on the geophysical exploration data. The geophysical exploration profile image is zoned according to the result of the on-site geological survey, so as to obtain the corresponding landslide geological model.

In addition, in step (S30), for the zoning of the electrical resistivity profile, stratum lithologic zones varying in the electrical resistivity ρ are formed, and are assigned with geotechnical parameters C and φ for numerical simulation, where C represents cohesion, and φ represents internal friction angle.

A physical parameter (the electrical resistivity ρ) and shear strength parameters (cohesion C and internal friction angle φ) of a large number of previously-known rock-soil masses are summarized or statistically analyzed and fitted to obtain a corresponding relationship model between the physical parameter and shear strength parameters. In this way, the corresponding rock shear strength parameter values can be obtained according to the existing geophysical exploration inversion result (the electrical resistivity ρ).

Stratum lithology conversion equations are obtained through mathematical statistics.

For a gravel soil, the stratum lithology conversion equations (1)-(2) are adopted, expressed as follows.

$$c = ( - 1.13 \times 1 {0}^{14} ) \times {e}^{- ρ / ( 1.12 \times 1 {0}^{13} )} + 1.13 \times 1 {0}^{14} \qquad ( 1 )$$

$$φ = \frac{- 22.19}{1 + {( ρ / 2.8 )}^{44.99}} + 60.4 \qquad ( 2 )$$

For a rock mass, the stratum lithology conversion equations (3)-(4) are adopted, expressed as follows.

$$c = \frac{- 11479.09}{1 + {( ρ / 2.78 )}^{20.33}} + 19518 \text{.89} \qquad ( 3 )$$

$$φ = \frac{- 4.78}{1 + {( ρ / 2.47 )}^{52.84}} + 32.85 \qquad ( 4 )$$

Relationship equations between the cohesion C and the electrical resistivity ρ and relationship equations between the internal friction angle φ and the electrical resistivity ρ are established. These relationship equations allow the values of cohesion C and internal friction angle φ to be rapidly obtained based on the value of the electrical resistivity ρ, thus achieving rapid numerical simulation calculation of landslide stability.

Finally, in step (S40), the preset condition is loaded into the established geological model, including a rainfall loading boundary condition, an earthquake loading boundary condition or a combination thereof, a stratum lithologic distribution depth condition and cohesion C and internal friction angle φ of individual stratum lithologic zones. The corresponding numerical model is established through the geological model, the landslide stability simulation calculation is performed in a numerical simulation software, so as to evaluate the landslide stability.

In this embodiment, rapid and accurate modeling of landslides can be achieved under the complex geological conditions. Moreover, rock and soil mechanical parameters (cohesion C and internal friction angle φ) can be rapidly obtained according to the geophysical exploration result, and are used for the numerical simulation calculation on landslide stability. This facilitates rapid calculation and high accuracy, and thus contributes to the evaluation of the landslide stability of the spatial structure.

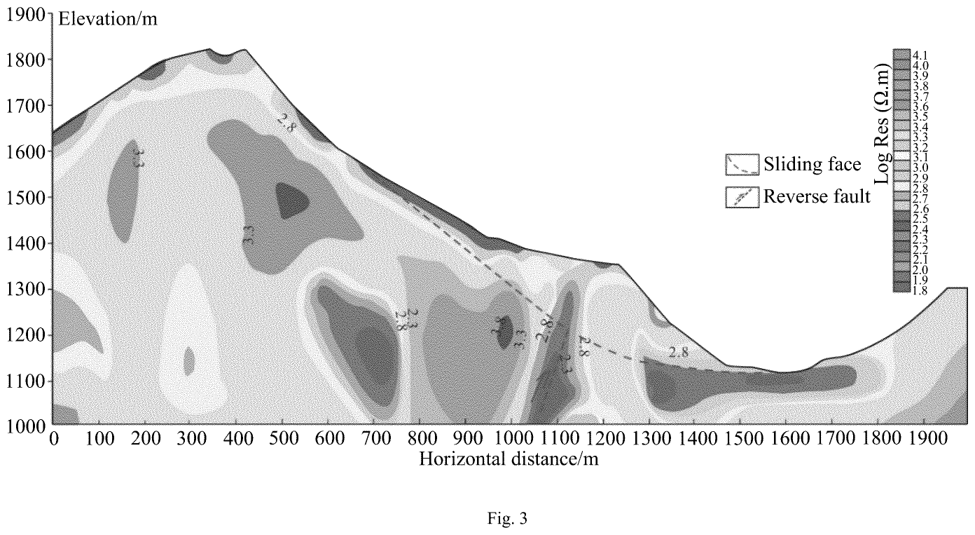

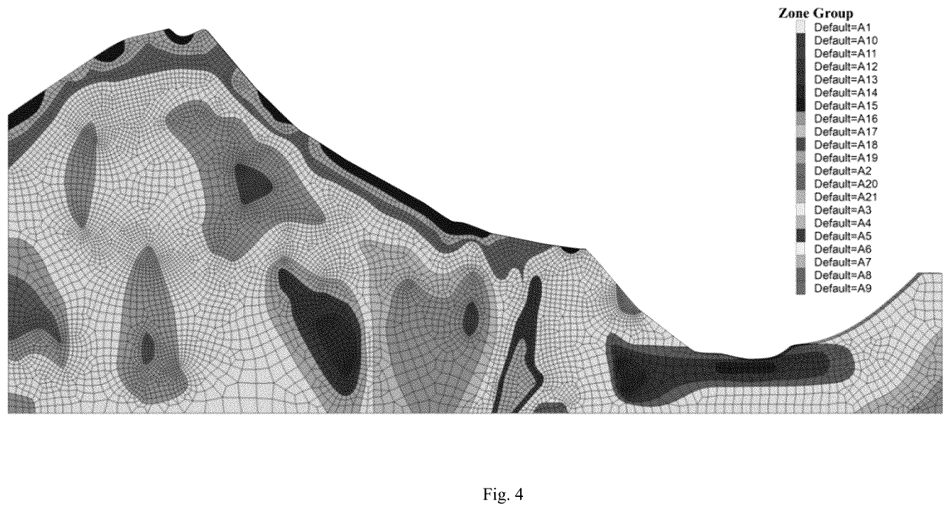

In an embodiment, geophysical exploration data of the landslide area is acquired. As shown in FIG. 3, an electrical resistivity profile of the landslide is generated by inversion of the geophysical exploration data. Combined with geological background data, the geophysical exploration result is interpreted, the to-be-detected rock-soil mass is zoned according to a lithology distribution characteristic, and special geological bodies (accumulation bodies, sliding zones, fracture zones) are delineated. In this way, a refined geological model is rapidly established. As shown in FIG. 4, 21 zone groups from A1 to A21 are obtained. Combined with the result of the geophysical exploration electrical resistivity profile, the electrical resistivity ρ is input into the relationship model between physical property parameters and rock-soil parameters (the Equations (1)-(2) or the Equations (3)-(4)), so as to rapidly obtain the values of cohesion C and internal friction angle φ (as shown in Table 1).

TABLE 1
Physical property parameters and geotechnical parameters

| Stratigraphic | | Electrical | | | Bulk | Shear | |
|---|---|---|---|---|---|---|---|
| lithology | | resistivity | | | modulus | modulus | Density |
| (zoning) | Name | value ρ (lg) | c/kPa | φ/° | K/GPa | G/GPa | (kg/m³) |
| A1 | Granite | 2.9 | 17000 | 60 | 60 | 25.64 | 2700 |
| A2 | Granite | 2.8 | 32 | 33 | 28 | 7 | 2300 |
| | (strongly | | | | | | |
| | weathered) | | | | | | |
| A3 | Crushed | 2.6 | 30 | 32 | 50 | 10 | 2000 |
| | zone | | | | | | |
| A4 | Crushed | 2.3 | 28 | 28 | 50 | 10 | 2000 |
| | zone | | | | | | |
| A5 | Crushed | 2.4 | 29 | 30 | 50 | 10 | 2000 |
| | zone | | | | | | |
| A6 | Granite | 2.7 | 30 | 32 | 28 | 7 | 2300 |
| | (fully | | | | | | |
| | weathered) | | | | | | |
| A7 | Granite | 2.6 | 10000 | 40 | 60 | 25.64 | 2000 |
| | (crushed) | | | | | | |
| A8 | Granite | 2.6 | 32 | 34 | 50 | 10 | 2000 |
| | (river | | | | | | |
| | infiltration) | | | | | | |
| A9 | Granite | 3.3 | 19000 | 60 | 60 | 25.64 | 2700 |
| A10 | Granite | 2.5 | 30 | 32 | 50 | 10 | 2000 |
| | (river | | | | | | |
| | infiltration) | | | | | | |
| A11 | Granite | 2.4 | 9000 | 38 | 60 | 25.64 | 2000 |
| | (crushed) | | | | | | |
| A12 | Granite | 2.4 | 28 | 30 | 50 | 10 | 2000 |
| | (river | | | | | | |
| | infiltration) | | | | | | |
| A13 | Granite | 2.3 | 8000 | 36 | 60 | 25.64 | 2000 |
| | (crushed) | | | | | | |
| A14 | Granite | 2.4 | 28 | 30 | 50 | 10 | 2000 |
| | (river | | | | | | |
| | infiltration) | | | | | | |
| A15 | Gravel soil | 2.4 | 25 | 26 | 22 | 6 | 1900 |
| A16 | Granite | 3.4 | 19000 | 60 | 60 | 25.64 | 2700 |
| A17 | Granite | 3.3 | 19000 | 60 | 60 | 25.64 | 2700 |
| A18 | Granite | 3.8 | 20000 | 60 | 60 | 25.64 | 2700 |
| A19 | Granite | 2.8 | 13000 | 45 | 60 | 25.64 | 2100 |
| A20 | Granite | 2.7 | 13000 | 45 | 60 | 25.64 | 2100 |
| A21 | Granite | 2.5 | 28 | 30 | 22 | 6 | 1900 |
| | (fully | | | | | | |
| | weathered) | | | | | | |

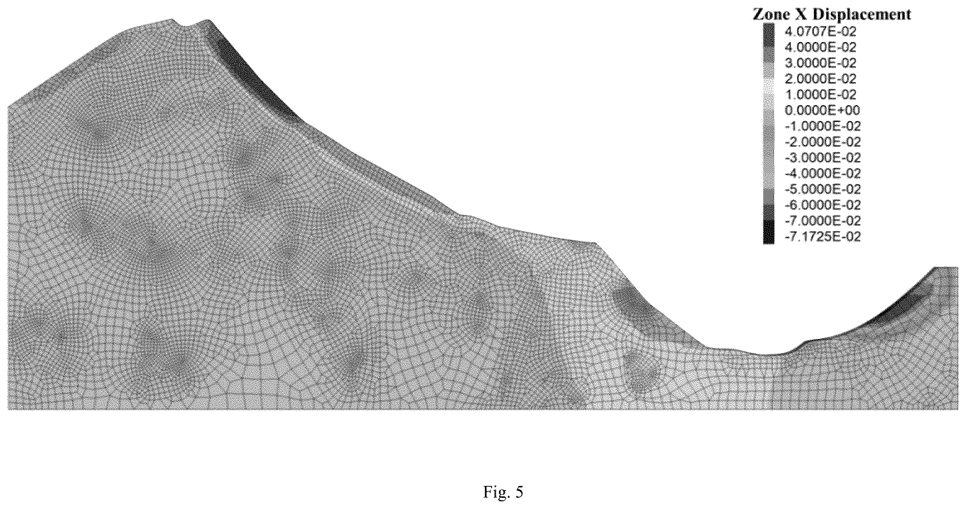

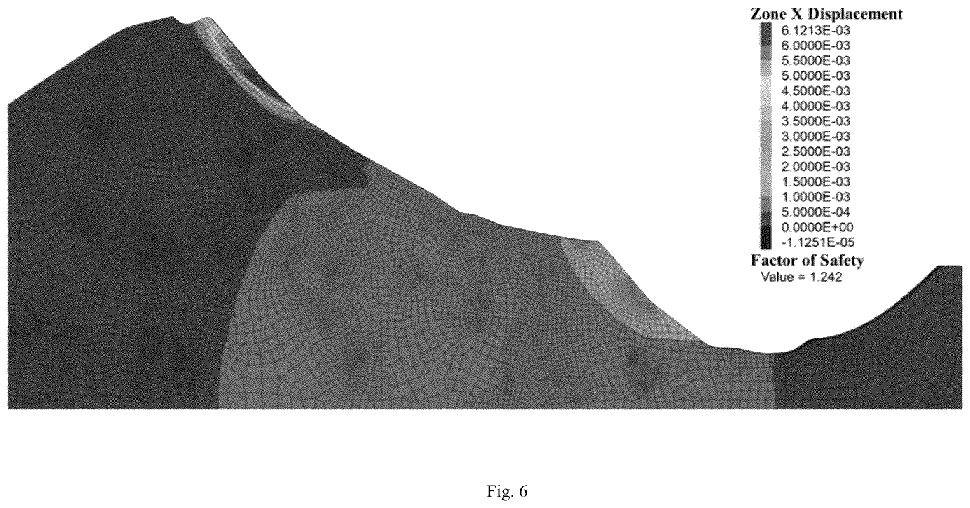

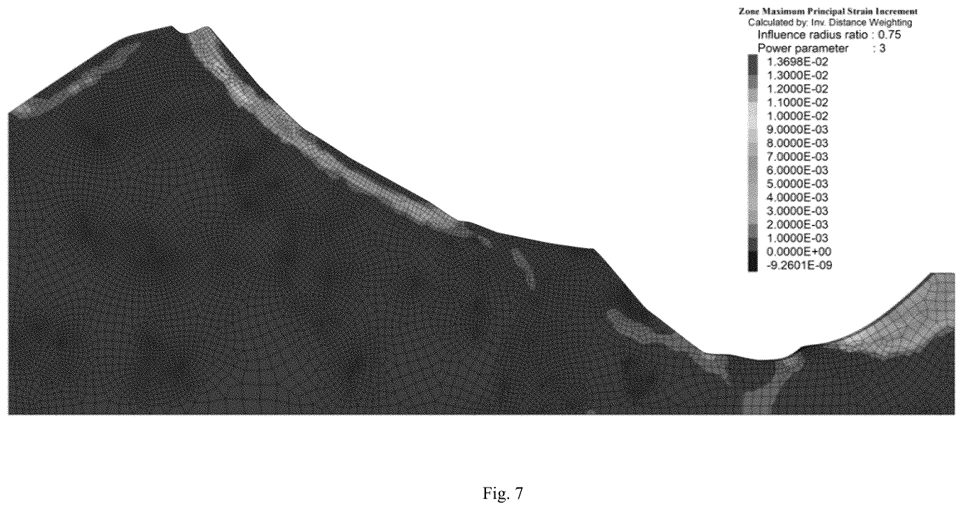

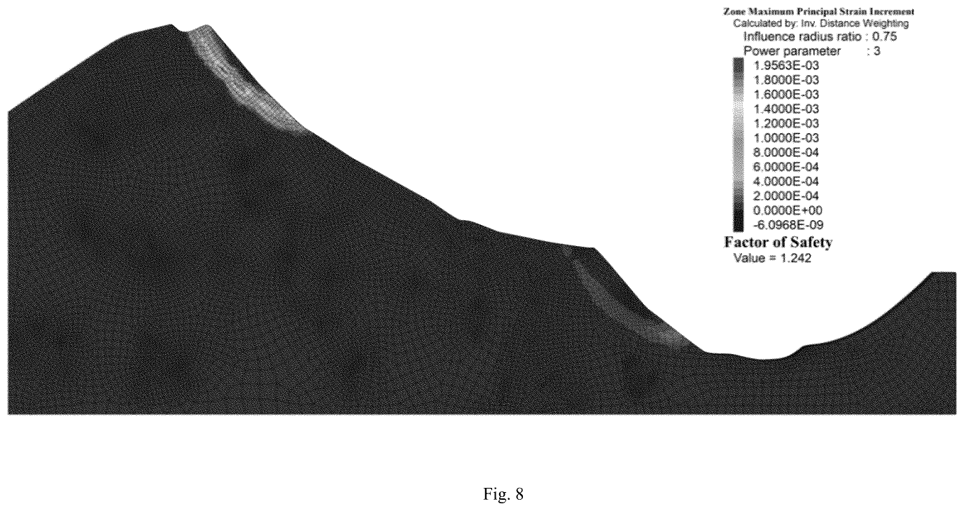

The geotechnical parameters and boundary conditions required for numerical simulation are input into the numerical model, and the numerical simulation calculation on the landslide stability is performed in the numerical simulation software, as shown in FIGS. 5-8. Finally, according to the result of the numerical model of the landslide stability, the stability of the landslide structure is evaluated. As shown in FIG. 6, a landslide stability coefficient Fₛ=1.242 is obtained through numerical simulation, which means that the landslide is in a stable state. However, it can be seen from the simulation result that the landslide has a characteristic of high-level shearing and a front edge that may slide down again.

In the present disclosure, according to the electrical resistivity profile combined with the conversion relationship between the shear strength parameters and the electrical resistivity of the rock-soil mass in the landslide, the corresponding shear strength parameters of the rock-soil mass can be acquired based on different resistivity values obtained by inversion. The geological model considering the geophysical exploration data of the landslide is established through the numerical simulation software to calculate the stability of the landslide body by simulation.

The present disclosure overcomes the problems of unclear understanding and inaccurate identification of the spatial structure of landslides under the complex geological conditions, thus rapidly establishing a landslide geological model that is more consistent with the actual landslide situation. In addition, the shear strength parameters of the rock-soil mass of the landslide can be rapidly obtained, and the numerical simulation calculation of the stability of the refined landslide geological model can be further performed, which leads to a more accurate numerical simulation result, thus achieving a rapid and accurate evaluation and analysis of landslide stability.

The above description is illustrative of the disclosure, and is not intended to limit the disclosure. It should be understood that various modifications, changes and replacements made by those skilled in the art without departing from the spirit of the disclosure shall fall within the scope of the disclosure defined by the appended claims.

What is claimed is:

1. A method for simulating landslide stability based on geophysical exploration data, comprising:
(S10) measuring an electrical resistivity ρ of a to-be-detected rock-soil mass in a landslide area, acquiring and processing geophysical exploration data of a profile of the landslide area, and generating an electrical resistivity profile by inversion based on the geophysical exploration data;
(S20) subjecting the electrical resistivity profile to interpret partition to establish a landslide geological model;
(S30) establishing a relationship model between shear strength parameters of a typical rock-soil mass and physical parameters of the typical rock-soil mass, and calculating shear strength parameters of the to-be-detected rock-soil mass according to the relationship model; and
(S40) loading a preset condition into the landslide geological model, and outputting a landslide stability numerical simulation result to evaluate stability of the landslide area;
wherein the step (S20) is performed through steps of:
(S201) interpreting and analyzing a result of the inversion according to the electrical resistivity profile in combination with on-site investigation and basic geological data;
(S202) subjecting the to-be-detected rock-soil mass to physical property measurement to obtain an electrical resistivity value corresponding to the to-be-detected rock-soil mass, analyzing electrical resistivity P values of a plurality of lithological zones on site, zoning the to-be-detected rock-soil mass according to lithological distribution characteristics, and delineating predefined geological bodies within the landslide area; and
(S203) establishing the landslide geological model comprising the electrical resistivity ρ;
the step (S30) is performed through steps of:
establishing the relationship model between shear strength parameters C and φ and an electrical resistivity ρ of the typical rock-soil mass; and calculating the shear strength parameters of the to-be-detected rock-soil mass according to the relationship model in combination with the electrical resistivity profile; wherein C represents cohesion, and φ represents internal friction angle;
the shear strength parameters C and φ of the typical rock-soil mass are calculated by substituting the electrical resistivity ρ values of the plurality of lithologic zones into preset equations (1)-(2) or preset equations (3)-(4);
for a gravel soil, the preset equations (1)-(2) are adopted, expressed as:
$$c = ( - 1.13 \times 1 {0}^{14} ) \times {e}^{ρ / ( 1.12 \times 1 {0}^{13} )} + 1.13 \times 1 {0}^{14} ; and \qquad ( 1 )$$
$$φ = \frac{- 22.19}{1 + {( ρ / 2.8 )}^{44.99}} + 6 0.4 ; \qquad ( 2 )$$
for a rock mass, the preset equations (3)-(4) are adopted, expressed as:
$$c = \frac{- 11479.09}{1 + {( ρ / 2.78 )}^{20.33}} + 19 518.89 ; and \qquad ( 3 )$$
$$φ = \frac{- 4.78}{1 + {( ρ / 2.47 )}^{52.84}} + 32 \text{.85} ; \qquad ( 4 )$$
in step (S40), the preset condition comprises a rainfall loading boundary condition, an earthquake loading boundary condition or a combination thereof, a stratum lithologic distribution depth condition and cohesion C and internal friction angle φ of each of the plurality of lithologic zones.
